(19) United States
(12) Patent Application Publication
(10) Pub. No.: US 2014/0164582 A1
(43) Pub. Date: Jun. 12, 2014

(54) METHOD AND SYSTEM FOR PROVIDING CONFIGURABLE COMMUNICATION NETWORK ROUTING

(71) Applicant: SXCVS XM Connected Vehicle Services Inc., Irving, TX (US)

(72) Inventors: James Dawson, Oceanside, CA (US); Frank Hirschenberger, Highland Village, TX (US); Tod Farrell, Coppell, TX (US)

(73) Assignee: SXCVS XM Connected Vehicle Services Inc., Irving, TX (US)

(21) Appl. No.: 14/098,217

(22) Filed: Dec. 5, 2013

Related U.S. Application Data
(60) Provisional application No. 61/733,931, filed on Dec. 6, 2012.

(51) Int. Cl. H04W 4/02

(52) U.S. Cl. CPC H04W 4/02
USPC 709/221

(57) ABSTRACT

An apparatus for managing a plurality of available network connections is disclosed. The apparatus has a plurality of communication modules. Each communication module provides a different mode of communication. The apparatus includes a configurable network database that stores configurable rules. The configurable rules are received by the configurable network database from a server. The apparatus also includes a connection manager that: manages the plurality of communication modules, and selects an appropriate connection from the plurality of communication modules based on the stored configurable rules located in the configurable network database.

### CROSS-REFERENCE TO RELATED APPLICATIONS

This application claims priority to U.S. Provisional Application Ser. No. 61/733,931, filed on Dec. 6, 2012), the entire disclosure of which is hereby incorporated herein by reference in its entirety.

### STATEMENT REGARDING FEDERALLY SPONSORED RESEARCH OR DEVELOPMENT

Not Applicable

### FIELD OF THE INVENTION

The present invention lies in the field of telecommunications. The present disclosure relates to telecommunications networks for use with various devices, e.g., safety devices, telematics, connected services, mobile devices, or automotive.

### BACKGROUND OF THE INVENTION

Current devices rely on locally managed network databases that require the user to interact directly with the device to manage network permissions, configurations, and authentication/passwords.

Presently, there exist no measures for providing per service data-bearer configuration based on cost, network quality of service (QoS), and/or service priority. For example, in present smart phones, the selection and configuration occurs only at the device. In addition, present smart phones do not provide per-service connection selectivity.

With respect to hybrid onboard or tethering systems, all configurations of these systems occur onboard. With respect to personal computers and tablets, all configuration occurs only at the device. Present personal computers and tablets do not provide per-service connection selectivity.

In the automotive space, current systems rely on a dedicated embedded connection, inserted communication (USB stick, etc.), or a tethered smart phone connection. There is no mechanism to differentiate the connection method based upon present conditions.

Thus, a need exists to overcome the problems with the prior art systems, designs, and processes as discussed above.

### SUMMARY OF THE INVENTION

The invention provides methods and systems for providing configurable communication network routing that overcome the hereinafore-mentioned disadvantages of the heretofore-known devices and methods of this general type.

With the foregoing and other objects in view, there is provided, in accordance with the invention, an apparatus for managing a plurality of available network connections. The apparatus has a plurality of communication modules. Each communication module provides a different mode of communication. The apparatus includes a configurable network database that stores configurable rules. The configurable rules are received by the configurable network database from a server. The apparatus also includes a connection manager that: manages the plurality of communication modules, and selects an appropriate connection from the plurality of communication modules based on the stored configurable rules located in the configurable network database.

In accordance with another feature of the invention, the plurality of communication modules include at least two of the following: a Bluetooth module; a Wi-Fi module; a Dedicated Short Range Communications/Wireless Access in Vehicular Environments (DSRC/WAVE) module; a cellular module; and a satellite module.

In accordance with a further feature of the invention, the apparatus communicates with an offboard server through a backhaul network.

In accordance with an added feature of the invention, networks are saved in the configurable network database.

In accordance with an additional feature of the invention, the apparatus includes an application and services module.

In accordance with yet another feature of the invention, the application and services module allows for a remote determination of a best available communication method.

In accordance with yet a further feature of the invention, the application and services module defers performing a service or application until a certain financial model for the service or application is present based on available communication measures.

In accordance with yet an added feature of the invention, the connection manager includes an internet protocol multiplexer that provides the ability to manage connections for one or more applications and one or more services; and a plurality of managers, each manager managing connections for a respective communication measure.

In accordance with yet an additional feature of the invention, each manager provides status information for the respective communication measure to the internet protocol multiplexer.

In accordance with again another feature of the invention, the configurable rules are saved in one or more tables.

In accordance with again a further feature of the invention, a first table is used to manage available connections for devices communicating through connections provided by the connection manager.

In accordance with again an added feature of the invention, a second table is used to manage available applications and services.

In accordance with again an additional feature of the invention, the one or more tables are configurable over the air from tables maintained in a centralized location.

In accordance with still another feature of the invention, the configurable rules are managed offboard.

In accordance with still a further feature of the invention, the configurable rules take into account priority data and quality of service data.

In accordance with still an added feature of the invention, the configurable rules allow for selection of an appropriate connection on a per application basis.

In accordance with still an additional feature of the invention, the configurable rules allow for selection of an appropriate connection on a per service basis.

In accordance with a further feature of the invention, the configurable rules allow for selection of an appropriate connection on a cost basis.

In accordance with an added feature of the invention, the configurable rules allow for selection of an appropriate connection using one or more usage parameters as a basis.

In accordance with a concomitant feature of the invention, the configurable rules allow for selection of an appropriate connection using service priority as a basis.

Although the invention is illustrated and described herein as embodied in methods and systems for providing configurable communication network routing, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a flow diagram of a system for providing configurable communication network routing, according to one exemplary embodiment;

FIG. 2 is a block diagram of onboard equipment, according to one exemplary embodiment;

FIG. 3 is a block diagram of an offboard server, according to one exemplary embodiment;

FIG. 4 is a block diagram of a high-level concept of a connection manager, according to one exemplary embodiment;

FIG. 5 is a block and flow diagram of an implementation of a system for providing configurable communication network routing, according to one exemplary embodiment;

FIG. 6 is a table illustrating an exemplary network configuration; and

FIG. 7 is a table illustrating an exemplary network configuration.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software,” “software application,” and the like as used herein, are defined as a sequence of instructions designed for execution on a computer system. A “program,” “software,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

A device that has a plurality of potential connections (including, but are not limited to, internal onboard cellular modules, coupled phone, Wi-Fi, Personal Area or Mesh networks (e.g., ZigBee), Satellite, Dedicated Short Range Communications/Wireless Access in Vehicular Environments (DSRC/WAVE) vehicle-to-vehicle (V2V) and vehicle-to-infrastructure (V2I)) is able to choose an appropriate connection based upon a set of over-the-air configurable usage rules on per-service basis (availability/quality, cost, priority, and usage parameters [allowed, mode, limits (e.g., time or money), etc.]). These rules are described in further detail below.

A remote server has network access credentials and configurations remotely populated. In one exemplary embodiment, the remote server can be pre-configured to allow access to trusted networks. The remote server can also manage third party access points.

In one exemplary embodiment, a single IP connection can be presented within the device, e.g., a mobile device at the application layer. However, in this embodiment, selection of the connection is driven by an abstracted connection manager.

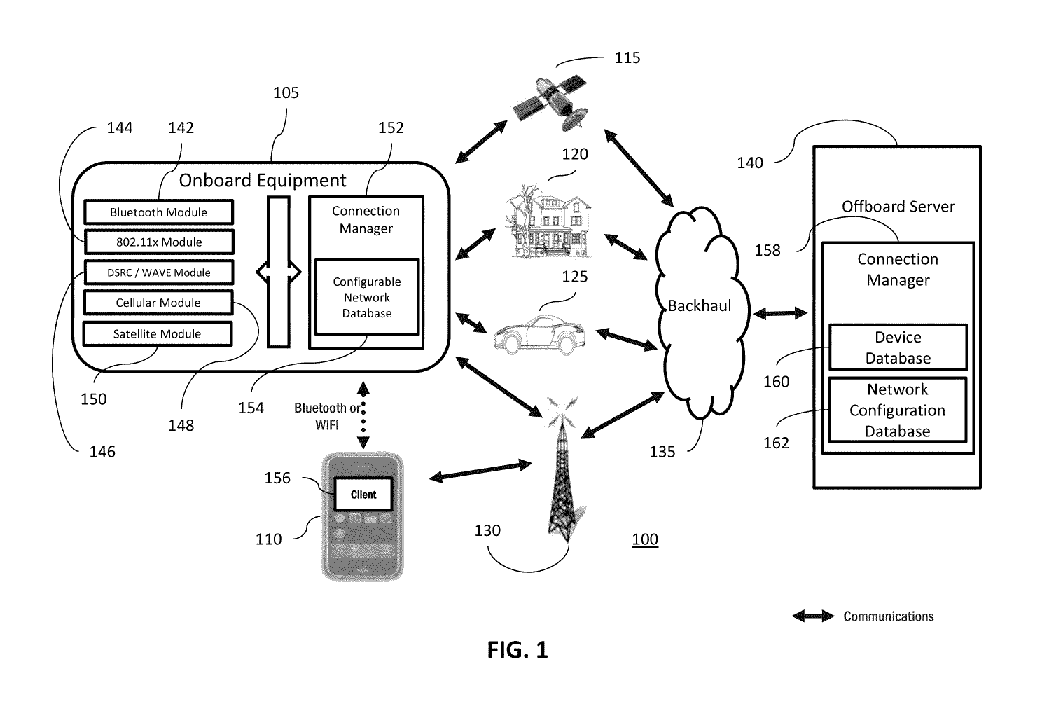

Described now are exemplary embodiments of the present invention. Referring now to the figures of the drawings in detail and first, particularly to FIG. 1, there is shown a first exemplary embodiment of a system 100 for providing configurable communication network routing. The system 100 includes onboard equipment 105, a mobile device 110, various communication measures 115, 120, 125, 130, a backhaul network 135, and an offboard server 140. The various communication measures shown include satellite 115, home network 120, vehicle to vehicle (V2V) 125, and wireless networks 130 but are not limited thereto. The wireless networks 130 can be a satellite, cellular, or a short-range wireless network, for example. Although the satellite 115 communication is shown as two-way in FIG. 1, this communication measure can also be configured as a one-way satellite communication, e.g., from backhaul network 135 through the satellite 115 and to the onboard equipment 105.

The onboard equipment 105 has various communication modules 142, 144, 146, 148, 150 and a connection manager 152. The various communication modules can include, for example, a Bluetooth module 142, a Wi-Fi (802.11x) module 144, a Dedicated Short Range Communications/Wireless Access in Vehicular Environments (DSRC/WAVE) module 146, a cellular module 148, and a satellite module 150.

The connection manager 152 allows the onboard equipment 105 to activate and connect to various networks using the various communication modules 142, 144, 146, 148, 150. Networks can be saved in a configurable network database 154.

The mobile device 110 can directly access the network 130 or use a Bluetooth, USB, or Wi-Fi connection to access the various communication measures 115, 120, 125, 130 through the onboard equipment 105. In one exemplary embodiment, the mobile device 110 runs a client application 156 that allows for a remote determination of the best communication method available based on availability/quality, cost, priority, and usage parameters. In one exemplary embodiment, the client application 156 defers performing a service or application until a better financial model for the service or application is present based on the available communication measure(s). In one exemplary embodiment, services or applications are completed based on the presently available communication measures independent of cost considerations.

The various communication measures 115, 120, 125, 130 are used by the mobile device 110 and/or the onboard equipment 105 to communicate with the offboard server 140 through the backhaul network 135. The offboard server 140 includes a connection manager 158, which utilizes a device database 160 and a network configuration database 162. The devices managed by the connection manager 158 of the offboard server 140 are saved in the device database 160. The managed devices represent devices that can be used, for example, by the onboard equipment to provide a network connection. The connection manager 158 manages the available connections for each device saved in the device database 160 based on pre-defined rules using the network configuration database 162.

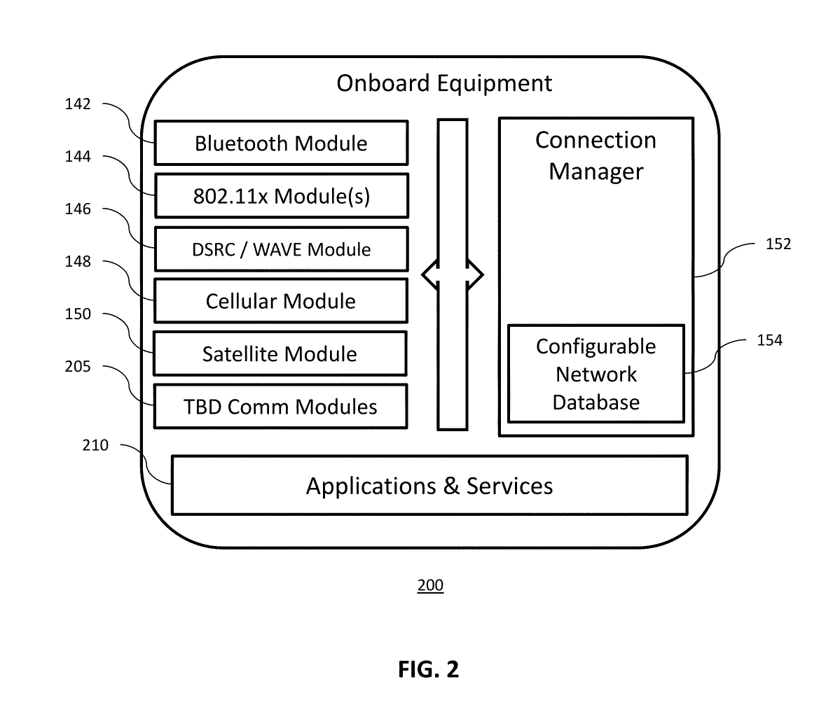

FIG. 2 illustrates onboard equipment 200, according to one exemplary embodiment. The onboard equipment 200 has various communication modules 142, 144, 146, 148, 150 and a connection manager 152. In this embodiment, the various communication modules include a Bluetooth module 142, a Wi-Fi (802.11x) module 144, a Dedicated Short Range Communications/Wireless Access in Vehicular Environments (DSRC/WAVE) module 146, a cellular module 148, a satellite module 150, and future or to be determined (TBD) communication modules 205.

The connection manager 152 allows the onboard equipment 200 to activate and connect to various networks using communication modules 142, 144, 146, 148, 150. Networks are saved in the configurable network database 154. The onboard equipment 200 also accesses various applications and services using applications and services module 210. For example, the onboard equipment 200 runs a client application 210 that allows for a remote determination of the best communication method available based on availability/quality, cost, priority, and usage parameters. In one exemplary embodiment, the client application 210 defers performing a service or application until a better (or certain) financial model for the service or application is present based on the available communication measure(s). In another exemplary embodiment, services or applications are completed based on the presently available communication measures independent of cost considerations.

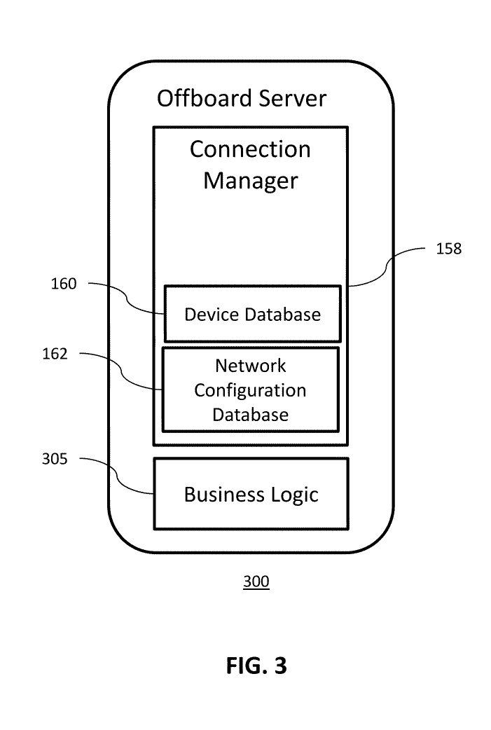

FIG. 3 illustrates an offboard server 300, according to one exemplary embodiment. The offboard server 300 includes a connection manager 158, which utilizes a device database 160 and a network configuration database 162. The devices managed by the connection manager 158 of the offboard server 300 are saved in the device database 160. The connection manager 158 manages the available connections for each device saved in the device database 160 based on pre-defined rules using the network configuration database 162. The pre-defined rules are implemented using a business logic module 305.

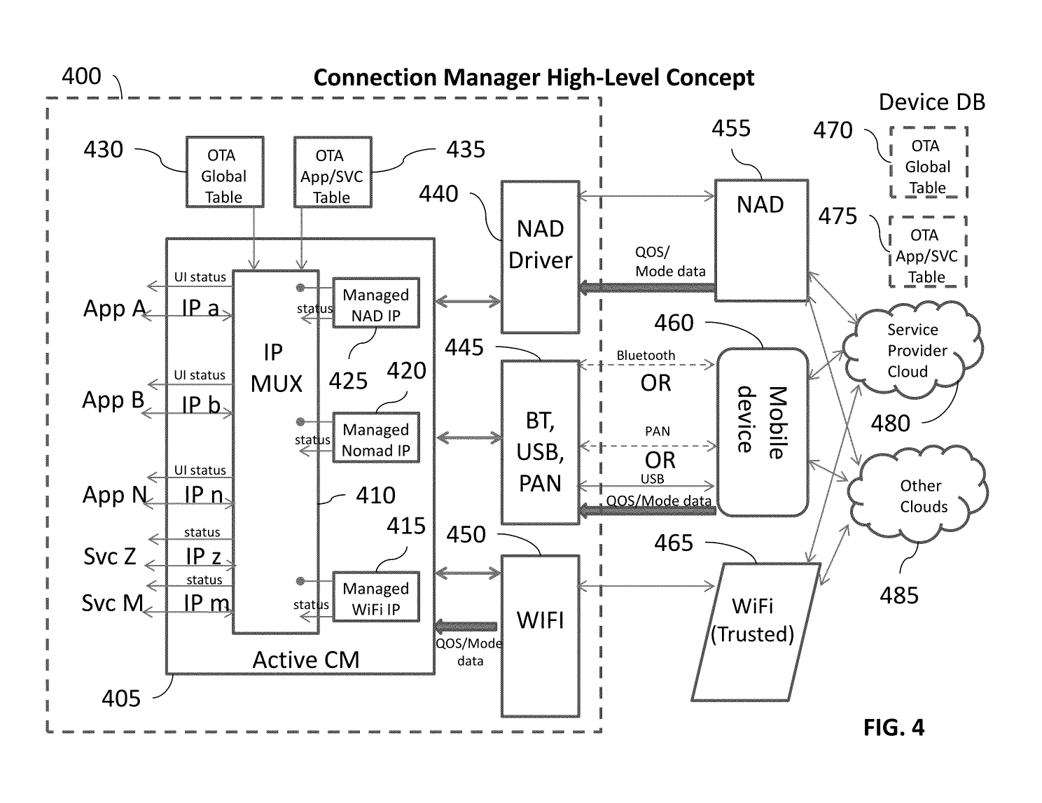

FIG. 4 illustrates further details of a connection manager 152, 405 for onboard equipment, e.g., onboard equipment 105, 200, 400, according to one exemplary embodiment. The connection manager 405 is an active connection manager that includes an internet protocol (IP) multiplexer (MUX) 410. IP MUX 410 provides the ability to manage connections for one or more applications (App A, App B, App N) and one or more services (Svc M, Svc Z). The connection manager 405 includes managers 415, 420, 425 to manage connections for its respective communication measure and the one or more applications and services. Pre-defined rules are saved in one or more tables 430, 435. Table 430 is a global table that is used to manage available connections for devices communicating through connections provided by the connection manager. Table 435 is a table that is used to manage the available applications and services. Tables 430, 435 are configurable over the air, for example, using rules saved in a centralized location, e.g., tables 470, 475.

In one embodiment, one or more tables, in this case, tables 470, 475 are stored in the network configuration database 162. The rules, e.g., one or more pre-defined rules or rule sets, located in tables 470, 475 can be updated in the centralized location and sent over the air and loaded into the tables 430, 435 stored in the configurable network database 154 of onboard equipment 105, 200, 405. Each of the one or more tables 430, 435, 470, 475 or portions of the one or more tables can be stored in one or more databases 154, 160, 162. The one or more databases 154, 160, 162 can be stored at one or more locations.

Manager 415 manages communications for a WiFi connection. Manager 415, in addition to managing traffic, also provides status information through the IP MUX 410 for the applications and services.

Manager 420 manages communications for nomad-type connections. In one embodiment, the nomad-type connection is a Bluetooth connection. In another embodiment, the nomad-type connection is a universal serial bus (USB) connection. Manager 420 manages traffic and provides status information through the IP MUX 410 for the applications and services.

Manager 425 manages communications for network access device (NAD) based connections. Manager 425 manages traffic and provides status information through the IP MUX for the applications and services.

The applications and services (App A, App B, App N, Svc M, Svc Z) are able to send and receive IP-based traffic to and from the IP MUX 410. In one embodiment, the IP-based traffic can occur among the various applications and services simultaneously. The applications receive status and data from the managers 415, 420, 425 through the IP MUX 410. The services are also able to receive status and data from the managers 415, 420, 425 through the IP MUX 410.

Modules 440, 445, 450 handle communications between various devices 455, 460, 465 and managers 415, 420, 425. NAD driver module 440 handles communications between NAD 455 and manager 425. NAD driver 440 also receives quality of service (QoS) and/or mode data from NAD 455. Although FIG. 4 only shows NAD, Bluetooth, USB, and Wi-Fi modules and corresponding managers, it should be apparent that modules present in onboard equipment 105, 200 can also be implemented in onboard equipment 400 with corresponding communication managers within connection manager 405. Likewise, elements shown only in FIG. 4 can also be implemented in the onboard equipment 105, 200 of FIG. 1 and FIG. 2. For example, FIG. 4 shows a USB module 445, which can be implemented in the onboard equipment 105, 200.

Module 445 is a personal area network (PAN), e.g., Bluetooth or other generic PAN, or USB module and handles communications between a mobile device 460, e.g., a smartphone or other mobile computing/communication device and manager 420. Module 445 supports communication with the mobile device 460 using a Bluetooth, PAN, or a standard USB connection. Module 445 also receives QoS and/or mode data from mobile device 460.

Module 450 is a Wi-Fi module that handles communications between a trusted Wi-Fi network 465 and manager 415. Module 450 provides QoS and/or mode data to manager 415.

NAD 455, mobile device 460, and Wi-Fi network 465 communicate with a service provider, e.g., cloud computing network 480. The service provider cloud 480 can, for example, implement offboard server 140. NAD 455, mobile device 460, and Wi-Fi network 465 can also communicate with other cloud computing networks 485.

The connection manager uses the rules data to manage the available connections. The connection manager can also implement rules that take priority and QoS data into account. For example, if there is a rule that USB or Bluetooth is a preferred communication method, a pre-defined sub-rule can be applied that allows for switching over to another access device when a quality of the connection becomes too low. In addition, the rules can specify that different connections are to be used for different applications or services.

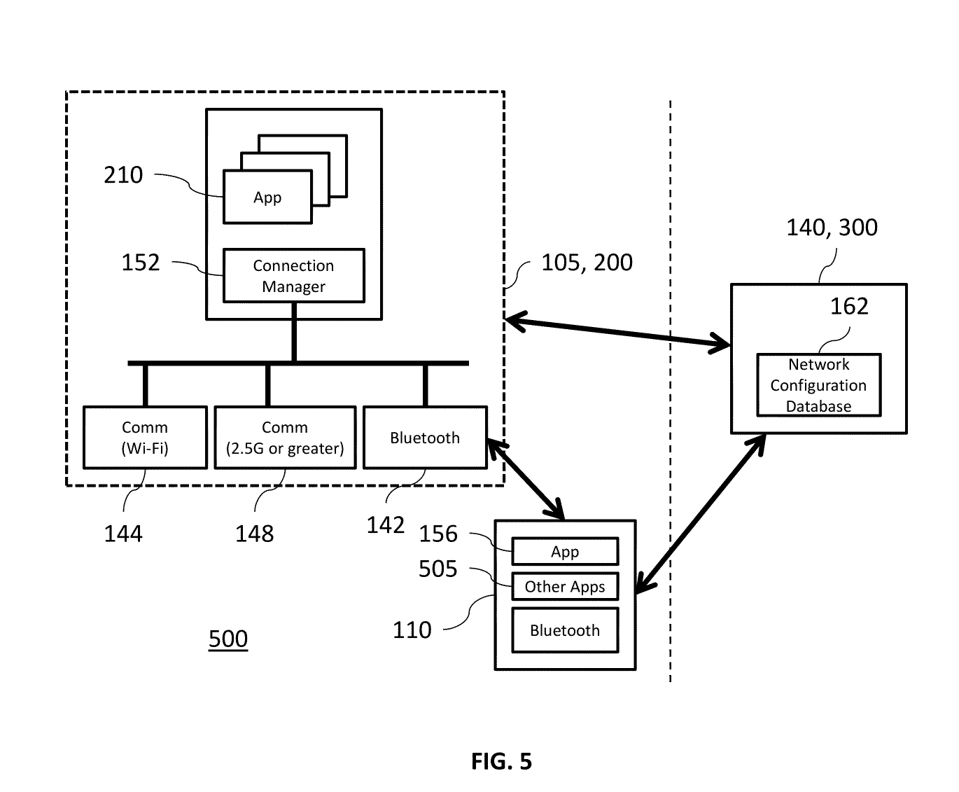

FIG. 5 illustrates an implementation of a system 500 for providing configurable communication network routing, according to one exemplary embodiment. In this example, the onboard equipment 105, 200 has a Bluetooth communication module 142, a Wi-Fi communication module 144, and a cellular communication module 148. The cellular communication module 148 may be compatible with a 2.5G or greater wireless network. The onboard equipment 105, 200 also has a connection manager 152 and is able to run one or more applications 210. The onboard equipment 105, 200 can be one or more individual components operating together. For example, onboard equipment can be embodied in one or more of a telematics control unit (TCU), data communications unit (DCU), data communications module (DCM), head unit (HU), etc. The TCU, DCU, and DCM can be portable or permanently installed in a vehicle. The HU is typically located in the dashboard area of a vehicle.

The connection manager 152 allows the onboard equipment 200 to activate and connect to various networks using the available communication modules 142, 144, 148. The mobile device 110 and/or the onboard equipment 200 are able to run a client application 156, 210 that allows for a remote determination of the best communication method available based on various rules, which can be dependent, for example, on availability, quality, cost, priority, and usage, to name a few. The mobile device 110 is also able to run other installed applications 505.

The remote determination of the best communication method is implemented at the offboard server 140, 300. For this, the offboard server 140, 300 includes a network configuration database 162. The network configuration database 162 is used to determine which communication method is to be used to provide one or more of the services.

The connection manager 152, 405 selects the communication method for the application 210 based on the set of rules received from the remote server 140, 300. The connection manager 152 tracks a presence of available devices and provides the presence information to the remote server 140, 300. Based on the presence information, the remote server 140, 300 updates the rules set and provides the updated rules set over-the-air to the client application(s) 156, 200 of the device(s) 105, 110, 200, 400. In one exemplary embodiment, the updated rules are saved in the centralized table 470 and provided over the air to table 430.

The application 156, 210 selects the communication method based on the set of rules received from the remote server 140, 300. The connection manager 152 tracks a presence of available devices and based on the presence information, the connection manager 152 accesses the configurable network database 154 and selects the appropriate access rules for the applications and services.

In one exemplary embodiment, instead of tracking presence information in real time, the connection manager 152 is pre-configured in the vehicle to handle certain potential communication methods. Priority is then allocated for the pre-configured communication methods per service type. If at any time the connection manager 152 detects a new unique communication method is available, the connection manager informs the server 140. The server 140 updates the connection manager 152 and the network configuration database 162 with a new set of rules to accommodate this new communication method.

The types of services available depend on the devices or communication measures that are present. For example, if a smart phone (i.e., mobile device 110) or a Wi-Fi network is present, certain types of information, entertainment, music, and/or video applications may be available. These application types are only set forth as examples.

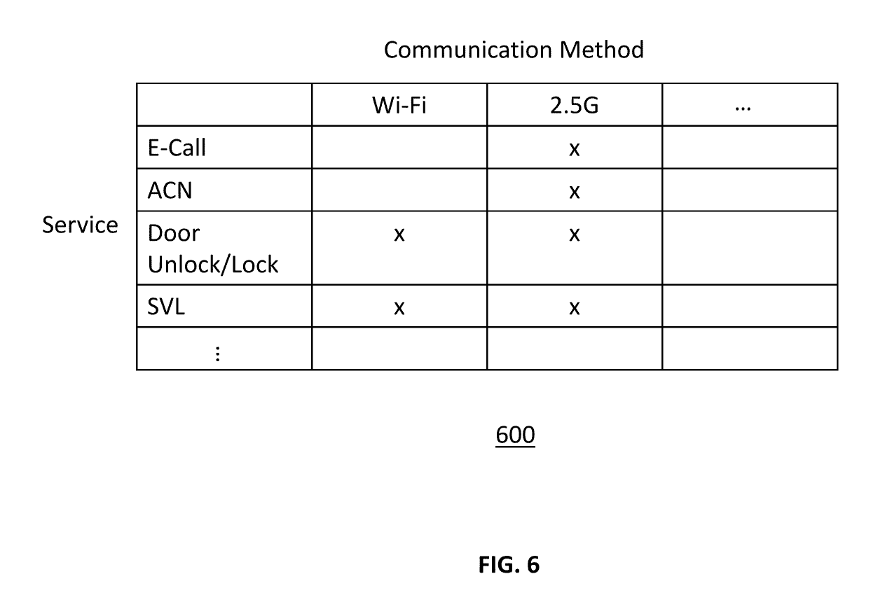

FIG. 6 illustrates an example network configuration table 600. In this example, the table 600 shows which services are to be used with which communication method. In this example, emergency calls (E-Call) and Automatic Collision Notifications (ACN) are only sent using a cellular module, e.g., cellular communication module 148, while Door Unlock/Lock and Stolen Vehicle Location (SVL) communications may be sent using either or both Wi-Fi 144 and cellular 148 communication modules.

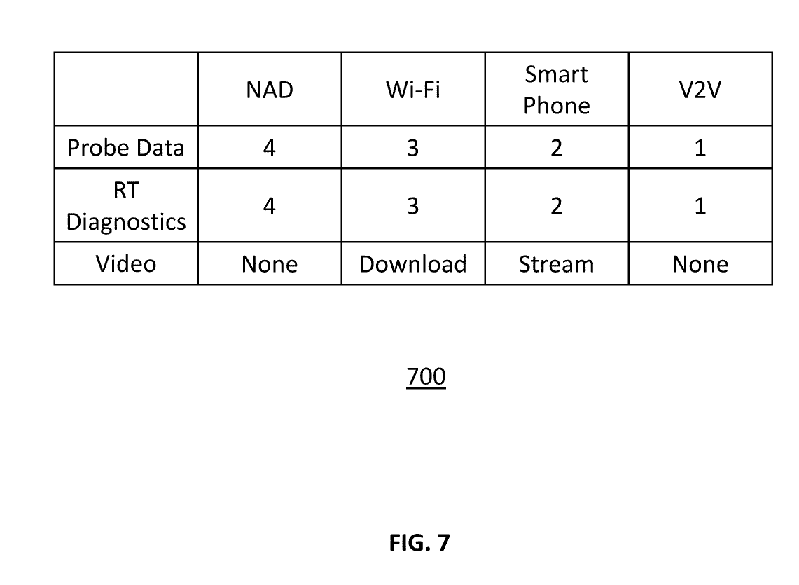

FIG. 7 illustrates another exemplary network configuration table 700. The table 700 shows the priority or capability assigned to each communication measure for each service. For example, four communication measures are shown: a network access device (NAD); a Wi-Fi 144; a smart phone 110; and a vehicle-to-vehicle (V2V) system 146. The NAD may be a cellular module 148 or a TBD module 205. For probe data, V2V has first priority, the smart phone has second priority, Wi-Fi has third priority, and the NAD has fourth priority. One example of probe data is traffic condition information. Another example of probe data is weather information (e.g., rain sensors, windshield wiper activity, external temperature). Probe data can also be: wireless network QoS; Wi-Fi network availability, position, and parameters; vehicle telemetry, driver telemetry, geographic information system (GIS) and road data, any current or future dynamic short range communication (DSRC)-type message; traction control activation; and lights status. For real-time diagnostics data, V2V has first priority, the smart phone has second priority, Wi-Fi has third priority, and the NAD has fourth priority. For video, the Wi-Fi module is only used for downloadable video and the smart phone is used to stream video. In this example, the NAD and V2V methods are not usable for video.

A remote server can have network access credentials and configurations remotely populated. In one exemplary embodiment, the remote server can be pre-configured to allow access to trusted networks, such as Wi-Fi. The remote server can also manage third party access points.

In an embodiment where the remote server 140, 300 is pre-configured to allow access to trusted networks, access credentials and configurations for one or more networks are stored in a network configuration database 162. One or more communication measures associated with the onboard equipment 105, 200, 400 and/or the mobile device 110 are stored in the device database. A rule set is generated by the remote server 140, 300. Once a device (car, mobile phone, personal computer, etc.) is registered for the service by a user, the device is added to the user's profile. Based on user preferences and device type, a set of rules and network access parameters is created and installed on the device.

There are many conceivable uses for the systems 100, 200, 300, 400, 500. In one exemplary embodiment, an appropriate connection can be chosen based upon a set of over-the-air configurable usage rules on a per-use basis. Where networks have been pre-defined at the offboard server 140, 300, a client (e.g., the mobile device 110 and/or the onboard equipment 105, 200) detects one or more available networks. The client 105, 110, 200 sends a notification of the one or more detected available networks to the server 140, 300. The client 105, 110, 200, 400 receives network access credentials from the server 140, 300 in response to the notification sent. The client 105, 110, 200, 400 connects to one of the available networks based on a rule set received from the server 140, 300.

Different embodiments of the invention may be implemented using different combinations of software, firmware, and/or hardware. Thus, the techniques shown in the figures, e.g., FIGS. 1 to 7, can be implemented using code and data stored and executed on one or more electronic devices (e.g., onboard equipment, an end station, a network element, an offboard server, a mobile device). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device.

Configurable Over the Air Rule Set

A device or application is able to receive a defined rule set for deciding which connection method and/or protocol to use, and this rule set is configurable over-the-air (OTA) for the life of the device. The choice of the connection method is handled offboard above an operating system level of the device. A device that has a plurality of potential connections is able to choose an appropriate connection based upon a set of over-the-air configurable usage rules, for example, on a per-service basis. Other bases for configurable usage rules are: availability/quality, cost, service priority, network quality of service (QoS), and usage parameters (allowed, mode, limits (e.g., time or money), etc.).

In one exemplary embodiment at the client, an appropriate connection can be chosen based upon a set of over-the-air configurable rules on a per-service basis. A client, e.g., the mobile device 110 and/or the onboard equipment 105, 200, 400 receives an indication of a user's intent to access a particular application or service 200, 505. The client 105, 110, 200, 400 sends the indication to the server 140, 300. The client 105, 110, 200, 400 receives a rule set in response to the sent indication and uses the rule set to determine the appropriate connection method for the application or service 200, 505.

In one exemplary embodiment at the server 140, 300, a notification of available communications methods is received from a client device 105, 110, 200, 400 by the server 140, 300. A rule set is determined based on the notification by the server 140, 300. The rule set is sent to the client 105, 110, 200, 400. The rule set is used by the client to determine a present communication method. The present communication method can be, but is not limited to, internal onboard cellular modules, a coupled phone, Wi-Fi, Personal Area or Mesh networks, Satellite, and DSRC/WAVE V2V and V2I. The rule set is managed offboard, e.g., at the server 140, 300, using a secure server-based application that allows for authentication, authorization and configuration management of the remote device, e.g., client 105, 110, 20, 400.

For vehicle applications, the communication measures are not required to change regardless of the connection method. The fact that the communication measures are not required to change allows for simplicity of software at the in-vehicle level. Thus, a single IP connection can be presented within the device at the application layer.

The present invention is able to create common connection interfaces to an application across a set of possible communications methods. Possible communications include, but are not limited to:
1) A cabled or wirelessly tethered application on a mobile device that provides a proxy-type interface between the smart phone's active network connection and the tethered application. This may be a mobile phone connected to a head unit via a standards-based method, e.g., Bluetooth profile, Wi-Fi association, or a proprietary custom protocol to provide wireless connectivity to the head unit to run cloud, native or hybrid, applications and services. This may also be a 4G wireless hotspot connected to a laptop or tablet providing network connectivity;
2) An application's choice of communication method to include proxy or ad-hoc communication through one or more V2V or V2I connections provided by nearby vehicles or infrastructure, including V2V selection points based upon real-time declaration of properties of each (and application layer decision-making);
3) A public or private Wi-Fi network;
4) A cellular network; and
5) A satellite network.

While connected vehicle service applications are discussed in the present disclosure, any person familiar with the art will understand that the invention can be applied in many M2M and mobile application vertices, including, but not limited to: Fleet Telematics; Fleet Tracking; Insurance Telematics; Personal/Home Connected Services; Automated Meter Reading/Smart Grid; Remote Telemetry; mHealth; Mobile Device Applications; Set-top Box Applications; and software bug reports from any mobile device.

Pre-Configured Wi-Fi Access

In one illustrative example, the remote server is pre-configured to provide Wi-Fi access information for all airport clubs for a particular airline. In this example, a user that is authorized to access the airport clubs for that airline can save authorization/authentication information at the remote server so that, when the pre-defined network is detected by the user's device 110, the user's device 110 can automatically establish a Wi-Fi connection with the pre-defined network without going through the authorization/authentication.

In another example, the remote server 300, 480 is pre-configured to provide Wi-Fi access information for a particular hotel chain or a third-party system used by more than one hotel chain. In this example, a user that is authorized to access the Internet through a Wi-Fi network of the hotel chain can save authorization/authentication information at the remote server 300, 480 so that, when the Wi-Fi network of the hotel chain is detected by the user's device 110, the user's device 110 automatically establishes the Wi-Fi connection, for example, using a room number and name saved at the remote server 300, 480 by the user.

Unknown Wi-Fi Network Evaluation

In one embodiment, the device 105, 110, 200, 400, upon detecting a Wi-Fi network that is unknown, queries the server to determine whether the unknown network is part of a set of networks that for which credentials are stored across all users. Hotel chains, major stores, and gas stations may be inclined to access credentials for all users of the system in order to drive business their way. In one exemplary embodiment, device 105, 110, 200, 400 collects and reports location and information on unknown networks so that the unknown networks can be evaluated and possibly included as new networks in the database.

Broadcast Over Satellite with Feedback Loop

In one embodiment, the pre-defined rules dictate that information is broadcast over satellite with a feedback loop over a cellular connection. In this embodiment, the information is broadcast over a satellite connection 115 and received by onboard equipment 105, 200, e.g., using satellite module 150. In one exemplary embodiment, the information that is broadcast can be an application that is being downloaded. In another exemplary embodiment, the broadcast information is related to a change to a component of the onboard equipment. Feedback with respect to a completion of items related to the broadcast information can be provided to the offboard server 140, 300 using cellular communication, e.g., through cellular module 148 or mobile device 110. In one exemplary embodiment, the information is broadcast over a wide area, such as a country or continent. In one exemplary embodiment, the feedback provided using cellular feedback is a completion rate.

Rules Update to Use Lower Cost Connection

In one exemplary embodiment, a pre-defined rules set uses an embedded communication module, e.g., of onboard equipment 105, 200, 400, for automatic crash notification (ACN) and diagnostic data transfer only. In this embodiment, a tethered mobile device is used for all other communications. If, at some point in the future, the wireless contract for the embedded module is updated and provides communication at a lower cost than the tethered mobile device, the rules can be updated to reflect the cost difference. In this embodiment, the rules are updated to have the embedded communication module serve as the default for all communications from the onboard equipment.

Priority Update Based on QoS Considerations

In one exemplary embodiment, the connection manager 152, 158, 405 can use a set of rules to prioritize a particular device for use with a particular application and use a lower priority device due to QoS considerations. In one exemplary embodiment, the mobile device 110, 460 is set in the OTA table as being the priority access device for an internet radio application. In one embodiment, the mobile device 110 is a smartphone. The initial priority is set in the pre-defined rules of the OTA table, e.g., tables 430, 435, 470, 475, for example, due to current NAD 455 data costs for the internet radio application. While a user is attempting to listen to the internet radio application, the connection manager detects that the smartphone 110, 460 network connection has dropped down and remains at 2G. In this scenario, a rule can be set to allow the NAD 455 to be used for the internet radio connection if the smartphone 110, 460 connection drops, e.g., from 4G or 3G, to 2G. The internet radio application is then able to provide a message on an associated graphical user interface that the network connection is being changed from the smartphone's 110, 460 network to the NAD 455 to continue the listening experience. In one exemplary embodiment, the rule can be set to allow the internet radio connection to remain with the NAD 455 until the smartphone 110, 460 connection goes up to 3G. In another exemplary embodiment, the rule can be set to allow the internet radio connection to remain with the NAD 455 until data usage reaches a certain amount. In yet another exemplary embodiment, the rule can be set to allow the internet radio connection to remain with the NAD 455 for a predetermined amount of time.

Subscription to Use Network Attached Device with an Application

In one exemplary embodiment, the connection manager 152, 158, 405 uses a rule that defaults to Wi-Fi as a top priority/choice for an in-vehicle voice-over-IP application that supports voice and/or video calling. In this embodiment, the rule sets the mobile device 110, 460, e.g., a smartphone, as the next or second priority to provide the IP connection. In one exemplary embodiment, a user is able to, through subscription management, set up the voice-over-IP application to be enabled for NAD 455 usage. In this embodiment, enablement of NAD 455 usage is set using the OTA application and services table 435, 475.

Permanent Turn-Off of Network Attached Device

In one exemplary embodiment, a network accessible device, e.g., NAD 455, can be turned off permanently, for example, due to obsolescence or a carrier business issue. In this embodiment, connected services (e.g., point of interest downloads, traffic, weather, etc.) for a particular vehicle were designed to run through the NAD 455. However, due to a network obsolescence issue, the NAD 455 is now unreliable. In this instance, the global OTA table 430, 470 can be updated by the original equipment manufacturer (OEM) to turn off NAD usage globally. In one exemplary embodiment, a simple bit set download can be used to turn off NAD usage. This method of turning off NAD usage can also be used in the case of a business issue where the OEM is required contractually to remove the units from the network or to modify the units due to carrier negotiation.

Temporal Management of Over the Air Reflash

In one exemplary embodiment, temporal management of priority is provided. In this embodiment, OTA reflash service rules are temporally managed. For example an OTA reflash of a critical update can start with the following priority: Wi-Fi (wait w days), the satellite (wait x days), then smartphone (wait y days), then finally NAD (wait z days). When it has been found that the percentage completion of the reflash is lagging behind, rules used by the connection manager can be updated in order to more quickly provide the update to a maximum amount of vehicles. For example, an OTA reflash service table can be modified so NAD 455 is set as the top priority and units can begin downloading expeditiously.

Usage-Based Insurance Data Upload

In one exemplary embodiment, usage-based insurance (UBI) data is uploaded according to certain priorities. For example, a UBI application upload can be set up with the following priorities: Wi-Fi (wait w days), then smartphone (wait x days), and finally NAD (wait y days). The priorities can be modified on a periodic basis by factoring timely data upload for the insurance company versus overall data costs for the UBI data upload program. In one exemplary embodiment, if data is needed more urgently, the configuration table(s) 430, 435, 470, 475 for the UBI application can be modified to facilitate uploading by any and all methods available.

Individual Application IP Connection Rule Update

In one exemplary embodiment, a rule update can be applied to individual application IP connections. For example, all applications, when launched, can be set to use only the mobile device 110, 460, e.g., a smartphone, for an IP connection. After some time, a determination can be made that a first application (e.g., an internet radio application) uses massive amounts of data while a second application (e.g., a local search application) is known to use less data. In this example, it is known that the second application is useful for all vehicle drivers and customer feedback shows that the second application only works when paired to a smartphone. In this example, an OEM can set the priority such that NAD 455 is used to provide data for the second application without having to provide data for the first application.

Vehicle to Vehicle Applications

In one exemplary embodiment, a shipping/receiving company has multiple vehicles in a fleet that utilize the onboard equipment 200. If one of the vehicles in the fleet has a satellite module 150 that does not work and the business logic 305 of the offboard server 300 has determined that a satellite connection is the fastest and/or cheapest communication method for which to send data, the vehicle can use a V2V connection with another vehicle in the fleet to access the other vehicle's satellite connection. V2V is a meant to be a fast, dynamic and cost-free connection, which lessens the need to set up security measures for the data being sent.

V2V contains inherent security and is dynamic, cheap, and flexible. In another exemplary embodiment, where there are multiple vehicles in a fleet having V2V capability, the newer vehicles can offer their newer, upgraded, higher bandwidth/lower cost communication methods to the older vehicles in the fleet.

In another exemplary embodiment, there is a branded “fleet” using V2V to aggregate anonymous usage, defect, and/or warranty data. As the vehicles wander and join adhoc networks, the data is aggregated to the “Spokescar”, which is the car in each group with the best and/or cheapest bandwidth. At a predetermined time, the Spokescar transmits all of the information acquired. The original equipment manufacturer (OEM) receives the information and uses inherent IDs in the data to discard any duplicates. However, duplicates are minimized because once car A passes its accumulation of data to car B, car A is no longer responsible for storing that data. Thus, car A can delete its data; each set of data should only exist in one Spokescar at a time.

Security System Access

In one exemplary embodiment, access to a home/office security system can be pre-configured at the remote server 140, 300. When the user indicates a desire to access the security system, which can be implemented using a wired or wireless network, the user is connected to the security system through the appropriate communication method 115, 120, 125, 130 based on the user's device 105, 110, 200, 400 and the rule set generated by the remote server 140, 300.

Pre-Configured Home Network

In another exemplary embodiment, access to a home network can be pre-configured at the remote server 140, 300. When the user's device, e.g., device 110, detects the home network, e.g., the communication method 120, the user's device can automatically establish a Wi-Fi connection, for example, using a network name and password saved at the remote server by the user. Private networks not broadcasting a service set identifier (SSID) can also be joined based on the device being in a known location.

Health Applications

In a further exemplary embodiment, a client application 156 can be implemented on a device used for electronic health (eHealth) or mobile health (mHealth) applications. Biometric monitors (heart rate monitor, blood pressure monitor, etc.) used in conjunction with device 110 can be configured to access available networks remotely from the remote server 140, 300. Using device 110 in this way allows for health information to be collected without the need to have an on-site technician.

In another exemplary embodiment, a mobile mhealth device (e.g., pedometer, heart meter, diabetic device) can gather data as the user wanders through life. The device is aware of the configuration for transmission and knows to update other devices and central servers when the “appropriate” method of communication is available. Low blood sugar requires a high reliability method. User A may consider calories burned highly critical while user B may consider calorie burn low but weight measurement of high criticality. So, a user-specific aspect can be applied to the rules as well.

Automated Meter Reading

With respect to Automated Meter Reading, various water, electrical, and other types of meters can and do form a mesh network. That mesh network can be used to forward data or notify other devices of available open communications methods. The system compares all notifications of available communication and chooses the most appropriate. A power outage detection at a meter or water outage detection at a water meter should be sent with high priority. The regular monthly download of usage information can be done over a lower cost and lower priority method. Basic diagnostics could be queued until a regular technician visit, however, now the technician just needs to penetrate the boundary of the mesh, not visit each home.

Software Bug Reports

With respect to software bug reports from any mobile device (e.g., phone, watch), the mobile device may have intelligence to report back to the manufacturer that a bug has occurred, but may not have a typically consistent low cost communications method. For example, some phones know when a system crash has occurred, however, many mobile devices store this data until synced with a computer and then use the computer to transmit the system crash data. As the mobile devices store defects, these devices could, like the “Spokescar” in the V2V example above, nominate a “Spokesdevice” to take over responsibility for transporting the data to the manufacturer in a method that does not cost the user.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

1. An apparatus for managing a plurality of available network connections, comprising:
a plurality of communication modules, each communication module providing a different mode of communication;
a configurable network database that stores configurable rules, the configurable rules being received by the configurable network database from a server;
a connection manager that:
manages the plurality of communication modules; and
selects an appropriate connection from the plurality of communication modules based on the stored configurable rules located in the configurable network database.

2. The apparatus of claim 1, wherein the plurality of communication modules include at least two of the following:
a Bluetooth module;
a Wi-Fi module;
a Dedicated Short Range Communications/Wireless Access in Vehicular Environments (DSRC/WAVE) module;
a cellular module; and
a satellite module.

3. The apparatus of claim 1, wherein the apparatus communicates with an offboard server through a backhaul network.

4. The apparatus of claim 1, wherein networks are saved in the configurable network database.

5. The apparatus of claim 1, further comprising an application and services module.

6. The apparatus of claim 5, wherein the application and services module allows for a remote determination of a best available communication method.

7. The apparatus of claim 6, wherein the application and services module defers performing a service or application until a certain financial model for the service or application is present based on available communication measures.

8. The apparatus of claim 1, wherein the connection manager further comprises:
an internet protocol multiplexer that provides the ability to manage connections for one or more applications and one or more services; and
a plurality of managers, each manager managing connections for a respective communication measure.

9. The apparatus of claim 8, wherein each manager provides status information for the respective communication measure to the internet protocol multiplexer.

10. The apparatus of claim 1, wherein the configurable rules are saved in one or more tables.

11. The apparatus of claim 10, wherein a first table is used to manage available connections for devices communicating through connections provided by the connection manager.

12. The apparatus of claim 10, wherein a second table is used to manage available applications and services.

13. The apparatus of claim 10, wherein the one or more tables are configurable over the air from tables maintained in a centralized location.

14. The apparatus of claim 13, wherein the configurable rules are managed offboard.

15. The apparatus of claim 10, wherein the configurable rules take into account priority data and quality of service data.

16. The apparatus of claim 10, wherein the configurable rules allow for selection of an appropriate connection on a per application basis.

17. The apparatus of claim 10, wherein the configurable rules allow for selection of an appropriate connection on a per service basis.

18. The apparatus of claim 10, wherein the configurable rules allow for selection of an appropriate connection on a cost basis.

19. The apparatus of claim 10, wherein the configurable rules allow for selection of an appropriate connection using one or more usage parameters as a basis.

20. The apparatus of claim 10, wherein the configurable rules allow for selection of an appropriate connection using service priority as a basis.

21. The apparatus of claim 1, wherein the configurable network database comprises one or more databases stored at one or more locations.
